(19) United States
(12) Patent Application Publication
(10) Pub. No.: US 2008/0313191 A1
(43) Pub. Date: Dec. 18, 2008

(54) METHOD FOR THE SUPPORT OF FILE VERSIONING IN FILE REPAIR

(75) Inventor: Imed Bouazizi, Tampere (FI)

Correspondence Address: FOLEY & LARDNER LLP, P.O. BOX 80278, SAN DIEGO, CA, 92138-0278, US

(73) Assignee: Nokia Corporation

(21) Appl. No.: 11/971,132

(22) Filed: Jan. 8, 2008

Related U.S. Application Data
(60) Provisional application No. 60/884,191, filed on Jan. 9, 2007.

(51) Int. Cl. G06F 17/30

(52) U.S. Cl. 707/10; 707/E17.032

(57) ABSTRACT

A system and method are provided for changing the file repair functionality associated with MBMS systems in order to allow for the unambiguous identification of a file version in the file repair request. A file repair request is extended by information that can globally, and independently of the file download session, identify the version of a file. According to one embodiment of the present invention, a last modification date of a file can be utilized in conjunction with the file's URL to identify the file and its version. According to another embodiment of the present invention, a hash value of the file can be utilized in conjunction with the file's URL to identify the file and its version.

### CROSS-REFERENCE TO RELATED APPLICATIONS

The present application claims priority to U.S. Provisional Patent Application No. 60/884,191, filed Jan. 9, 2007.

### FIELD OF THE INVENTION

The present invention relates generally to mobile broadcast/multicast services (MBMS). More particularly, the present invention relates to file repair functionality features utilized in conjunction with MBMS.

### BACKGROUND OF THE INVENTION

This section is intended to provide a background or context to the invention that is recited in the claims. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

Mobile multicast and broadcast systems have recently been standardized by different organizations, such as the 3^{rd} Generation Partnership Project (3GPP) Multimedia Broadcast/Multicast Service (MBMS), the Digital Video Broadcasting (DVB) Convergence of Broadcast and Mobile Services (CBMS), and the Open Mobile Alliance (OMA) Mobile Broadcast Services (BCAST) organizations. The two primary services provided by such multicast/broadcast solutions are streaming and file delivery services. Although streaming services are considered to be the primary driver of the technology (e.g., the Mobile TV application), file delivery is expected to generate a significant amount of the traffic, as well as a significant amount of the revenues. For example, in the delivery of music and video clips, the file delivery may comprise the primary application component. Alternatively, file delivery may be a secondary component of the application, such as in the case of rich media applications and zapping streams.

In the case of file delivery, File Delivery over Unidirectional Transport (FLUTE) can be used as the file delivery protocol. As discussed in the Network Working Group's Request for Comments (RFC) 3926, which can be found at www.ietf.org/rfc/rfc3926.txt and is incorporated herein by reference in its entirety, FLUTE is defined by the Internet Engineering Task Force (IETF), and a revision of this document is currently in progress. FLUTE is based on Asynchonous Layered Coding (ALC) Protocol Instantiation, which can be found in RFC 3450 (www.ietf.org/rfc/rfc3450.txt, incorporated herein by reference in its entirety.) ALC comprises a set of building blocks such as the Layered Coding Transport (LCT) block, which can be found in RFC 3451 (www.ietf.org/rfc/rfc3451.txt, incorporated herein by reference in its entirety) and the Forward Error Correction (FEC) building block, which can be found in RFC 3452 (www.ietf.org/rfc/rfc3452.txt, incorporated herein by reference in its entirety). FLUTE extends ALC by, among others, defining mechanisms to describe the contents of the FLUTE session. This is achieved by introducing a well-known object with a Transport Object Identifier (TOI) equal to 0, carrying a File Delivery Table (FDT) instance. The FDT instance lists a set of files and their corresponding transport options. The FDT is an XML file following a schema defined in the FLUTE specification, where the semantics of the FDT are primarily taken from the HTTP 1.1 protocol (as which can be found at www.ietf.org/rfc/rfc2616.txt, incorporated herein by reference in its entirety).

3GPP is currently specifying extensions to the Multimedia Broadcast/Multicast Service (MBMS) file download and streaming methods (ETSI TS 126 346, Universal Mobile Telecommunications System (UMTS); Multimedia Broadcast/Multicast Service (MBMS); Protocols and Codecs (3GPP TS 26.346), incorporated herein by reference in its entirety). One of the goals of these extensions is to enable service delivery over a unicast session. This is especially important in the case where users happen to leave a multicast coverage area and only have the unicast channel available for data reception. The enabling of service delivery over a unicast session is accomplished by providing for appropriate signaling so as to indicate to the receiver the existence of an alternative unicast session that delivers the same content as the multicast/broadcast session.

During the lifetime of a file download session, new versions of the files may become available and are delivered to the receivers to replace an old version of the files. An example of such a service may be a stock market information service that delivers updates of current share prices to a receiver. Receivers that fail to recover the file from the received encoding symbols and the FEC repair symbols may try to perform a file repair operation to retrieve the missing encoding symbols.

The current file repair syntax as defined in the 3GPP TS 26.346 specification, noted above, does not allow the receiver to specify which file version the request relates to. The only identification of the file that is allowed is the file Uniform Resource Locator (URL), which is the same for all of the versions of a file. As a consequence, the recovery of the file may be erroneous when encoding symbols of a different version are retrieved from the repair server/service.

FIG. 1 illustrates an example of when this ambiguity can occur in conjunction with a file repair request. The system described in FIG. 1 includes at least a file delivery server 100, a client 110 that wishes to receive/download a file from the file delivery server 100, and a repair server 120 for transmitting, for example, missing encoding symbols not received by the client 100 during the file download. Delivery of the FDT n from the file delivery server 100 to the client 110 is represented at 130, where the FDT n includes File 1, Version 1. Delivery of the File 1, Version 1 to the client 110 is represented at 135. At 140, a portion of the File 1, Version 1, for example, a last portion, that is not received is indicated. Alternatively, 140 can indicate that the last portion of the File 1, Version 1 was received with a defect, for example. A repair request for the File 1 initiated by the client 110 to the repair server 120 is represented at 145.

At some time between the transmission of the repair request and the transmission of the missing encoding symbols representative of the last portion of File 1, a new version, i.e., File 1, Version 2 becomes available. Delivery of the FDT n+1, which includes the File 1, Version 2 to the client 110 is represented by 150. Delivery of the encoding symbols of the File 1, Version 2 that are consequently not delivered to the client 110, for example, for the same reason that the delivery of the last portion of the File 1, Version 1 was not completed, are represented at 155. At 160, a “Repair Request File 1, Version 2” message for the delivery of the File 1, Version 2 to the client 110 is shown. However, the File 1, Version 2 was not actually requested by the client 110. Rather it was a repair request for the File 1, Version 1. Hence, the repair request is ambiguous in that there is no mechanism for indicating which version of a particular file, the repair request is directed to.

Therefore, a need exists for defining a technique to uniquely identify a version of a file in order to ensure that the file repair functionality behaves correctly. Two different solutions have previously been proposed to address ambiguity problems. A first solution involves timing considerations. A proposal that was adopted in DVB CDP implementation guidelines (IP Datacast over DVB-H: Content Delivery Protocols (CDP) Implementation Guidelines TM-CBMS 1483/TM 3460 Rev. 3) provides a process for selecting file repair intervals in such a way that they do not overlap for different versions of a file. Because repair requests are conventionally assumed to be initiated only during those file repair intervals, the file version of the request can be uniquely identified. However, a drawback to this first solution is that limitations/requirements must be set for the time intervals of the repair requests that need to be signaled to a receiver in a service announcement. The receiver is then not allowed to send repair requests at times outside of the file repair request intervals.

A second solution involves including the TOI of a file in the repair request. The TOI is then used to identify the version of the file to which the missing or defective, requested encoding symbols belong to. However, this merely results in an incomplete solution, as the TOI must still be scoped by an associated Transport Session Identifier (TSI) and the sender address. The same value of the TOI can be used by several FLUTE servers to refer to different versions of a file, so that a TOI value alone is not enough. Even adding these parameters to the request URL does not result in a satisfactory solution because the size of the request line is significantly increased due to the inclusion of the extra parameters. In addition, such a solution limits available possibilities for implementing the repair server, where the repair server needs to maintain a list of all file download sessions that carry a given file as well as the different TOI values that are used in each of these file download sessions.

### SUMMARY OF THE INVENTION

Various embodiments of the present invention provide changes to the file repair functionality in order to allow for the unambiguous identification of a file version in the file repair request. A repair request is extended by information that can globally, and independently of the file download session, identify the version of a file. According to one embodiment of the present invention, a last modification date of a file can be utilized in conjunction with the file's URL to identify the file and its version. According to another embodiment of the present invention, a hash value of the file can be utilized in conjunction with the file's URL to identify the file and its version.

The various embodiments of the present invention have the advantage of creating a more robust method of identifying file versions delivered in a file download session over FLUTE. In addition, the various embodiments of the present invention allow for more flexibility in realizing/implementing a file repair service because the synchronization effort needed to synchronize between a file delivery server and the file repair server is minimized.

These and other advantages and features of the invention, together with the organization and manner of operation thereof, will become apparent from the following detailed description when taken in conjunction with the accompanying drawings, wherein like elements have like numerals throughout the several drawings described below.

### BRIEF DESCRIPTION OF THE DRAWINGS

FIG. 1 illustrates a message flow representation of an ambiguous file repair request;

FIG. 2 illustrates a message flow representation of MD5 checksum usage in accordance with one embodiment of the present invention;

FIG. 3 illustrates a message flow representation of a last modification date feature implemented in accordance with another embodiment of the present invention;

FIG. 4 is an overview diagram of a system within which the present invention may be implemented;

FIG. 5 is a perspective view of a mobile device that can be used in the implementation of the present invention; and

FIG. 6 is a schematic representation of the device circuitry of the mobile device of FIG. 5;

### DETAILED DESCRIPTION OF THE PREFERRED EMBODIMENTS

The various embodiments of the present invention improve the file repair functionality defined in Protocols and Codecs, which can be found at 3GPP TS 26.346 (as which can be found at www.3gpp.org/ftp/Specs/archive/26_series/26.346/, incorporated herein by reference in its entirety). Therefore, the various embodiments of the present invention are able to provide unambiguous identification of a version associated with a file for which the file repair request is initiated. The unambiguous identification of the version of a file is accomplished by extending the repair request with information that can globally, and independently of the file download session, identify the version of the file.

According to one exemplary embodiment of the present invention, a last modification date of a file can be used in conjunction with the file's URL to identify that file and the file version. According to another exemplary embodiment of the present invention, a hash value of the file can also be used in conjunction with the file's URL to identify that file and the file version. The URL of the file uniquely identifies a given file. When the URL of the file is combined with the last modification date of the file and/or the hash value of the file, the file as well as the file version can be uniquely identified.

The last modification date of a file indicates when a specific version of the file has been created. It can be assumed that two versions of the same file will not share the same modification date. It should also be understood that the modification date can refer to a particular calendar date, for example, and to a time. Defining the modification date in this manner further helps to ensure that the two versions of the same file will not share the same modification date.

The hash value of the file is a value that can be computed relative to/over the entire file. Therefore, the hash value of the file can be used to uniquely identify a version of the file as it can be assumed that no two versions of the file will produce the same hash value.

Implementing the various embodiments of the present invention include a process for signaling an identifier of the file version to the receivers. The signaling of the file version preferably takes place in the FDT, but can occur elsewhere. The hash value is already defined in the FDT in the form of an Message-Digest algorithm 5 (MD5) checksum, which can be found in RFC 1321 (www.ietf.org/rfc/rfc1321.txt, incorporated herein by reference in its entirety). An example of an FDT with the MD5 value is implemented with the following syntax:

<?xml version=“1.0” encoding=“UTF-8” standalone=“no” ?>

<FDT-Instance xmlns=“http://www.example.com/flute”
Expires=“3396186000”>

<File Content-Location=“music.mp3” Content-Type=“
audio/mp3” TOI=“9”

Content-MD5=”A3DC4902FB2ECE812845AD0D0AA”/>
</FDT-Instance>

The MD5 hash value is encoded using base 64 encoding, although it should be understood that other encoding techniques can be utilized. In addition, other hash value algorithms may be used as well.

Alternatively, as described above, a “Last-Modified” element can be introduced into the file, which carries a timestamp that indicates the date and time of creation and/or modification of a current version of the file. An example of an FDT with the Last-Modified element is implemented with the following syntax:

<?xml version=“1.0” encoding=“UTF-8” standalone=“no” ?>

<FDT-Instance xmlns=“http://www.example.com/flute”
Expires=“3396186000”>

<File Content-Location=“music.mp3”
Content-Type=“audio/mp3” TOI=“9”

Last-Modified=”337418723”/>
</FDT-Instance>

It should be noted that the Last-Modified element can be a Network Time Protocol (NTP) timestamp or it may be a date and time value as defined in HTTP 1.1. In one particular embodiment, the resolution of such a date and time indication be at least on the order of seconds. Although any desired resolution can be implemented, a smaller resolution can better ensure that no two different file versions will share the same creation date. For example, as described above, a resolution on the order of days could easily result in more than one version of a file being modified in a single day.

Implementing the various embodiments of the present invention also includes a process for filing a repair request with an indication of a file version. To accomplish this, a file repair request can be modified to include an indication of the file version that is requested. Depending on the file description included in the FDT, at least one of the modification date and the hash value is used as the indication.

An example of a file repair request using an MD5 hash value is shown below:

GET /file_repair_service?fileURI=www.news.example.com/latest/music.mp3&Conte
nt-MD5=A3DC4902FB2ECE812845AD0D0AA&SBN=0;ESI=12,78&SBN=2
HTTP/1.1
Host: http://ipdcrepair.operator.com

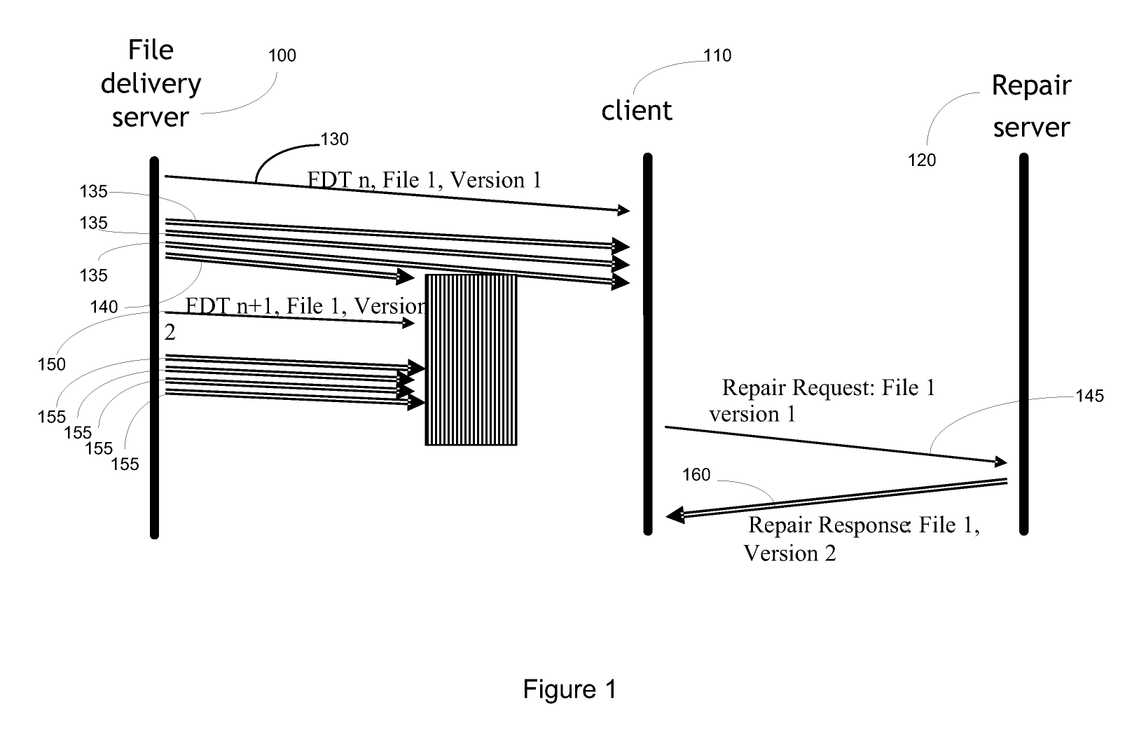

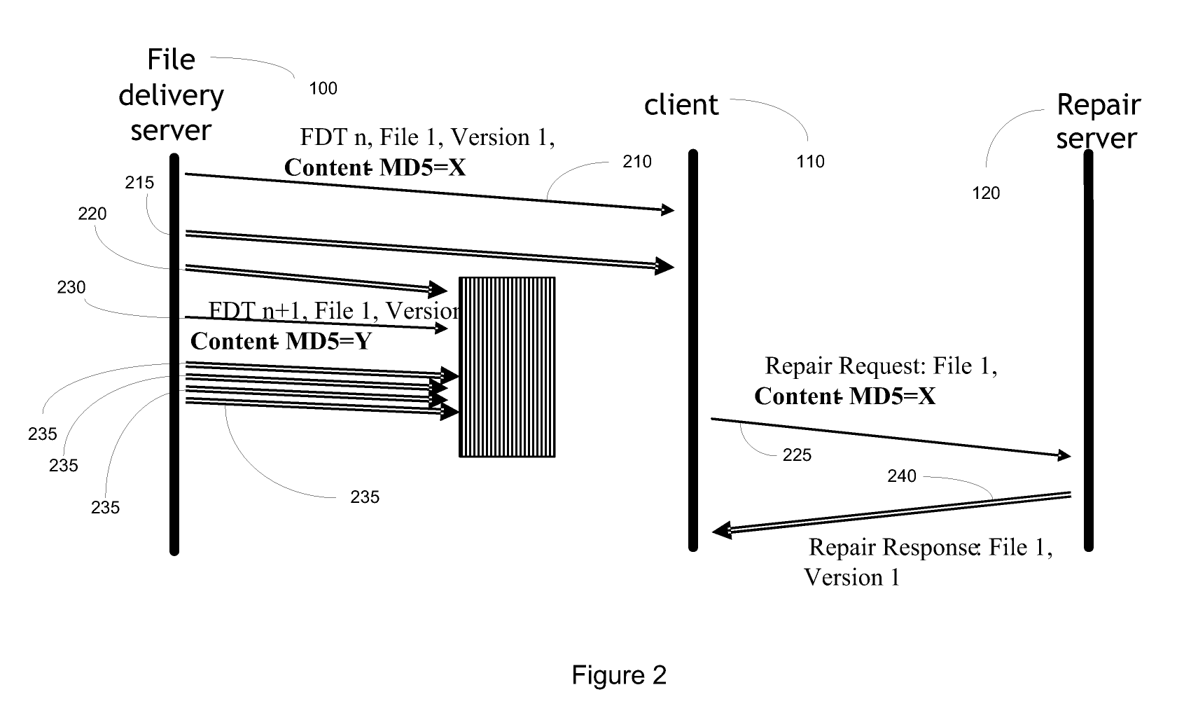

FIG. 2 shows a messaging diagram illustrating the file repair request process where the MD5 hash value is transmitted in the FDT. The system shown in FIG. 2, like the system shown in FIG. 1 includes at least a file delivery server 100, a client 110, and a repair server 120. Delivery of the FDT n from the file delivery server 100 to the client 110, where the FDT n includes File 1, Version 1 is represented at 170. In addition, the FDT includes an MD5 hash value of X. Delivery of the File 1, Version 1 to the client 110 is shown at 175. A portion of the File 1, Version 1 that is not received by the client 110 is indicated at 180. Alternatively, 180 can indicate that this portion of the File 1, Version 1 was received, for example, with a defect.

At some time between the transmission of the file repair request and the transmission of the missing encoding symbols representative of the last portion of File 1, a new version, i.e., File 1, Version 2 becomes available. Delivery of the FDT n+1, which includes the File 1, Version 2 and an MD5 hash value of Y to the client 110 is represented at 190. Delivery of the encoding symbols of the File 1, Version 2 that are consequently not delivered to the client 110 is represented at 195. Unlike the ambiguous file repair request shown in FIG. 1, however, 185 represents a file repair request for the File 1 initiated by the client 110 to the repair server 120, where the request also includes the MD5 hash value indicator that the File 1 version requested is Version 1. Therefore, the repair server 120 responds to the file repair request with the proper version of File 1, i.e., Version 1 because File 1, Version 1 and File 1, Version 2 can be differentiated via their respective MD5 hash values of X and Y.

The response to the repair request includes the repair server delivering the requested encoding symbols associated with the File 1, Version 1 to the client 110. In one embodiment, the requested file, i.e., File 1, Version 1 is already available at the repair server 120 before the start of the file repair session, for example, via an earlier interaction between the repair server 120 and the file delivery server 100. The repair server 120 also can have information regarding an appropriate blocking algorithm that is used for dividing the file into source blocks to be able to reproduce the requested encoding symbols according to the FLUTE session at the original server, i.e., file delivery server 100. Alternatively, the repair server 120 can be a receiver of the FLUTE session from the file delivery server 100. It should be noted that the repair server 120 behavior for acquiring files from the file delivery server 100 is implementation-specific. For scalability purposes, the repair server 120 can, but does not need to, have files available locally, instead of having to forward requests for the repairing, e.g., the resending of missing encoding symbols, to the file delivery server 100.

An example of a file repair request having a Last-Modified element included therein is shown below:

GET /file_repair_service?fileURI=www.news.example.com/latest/music.mp3&Last-
Modified=”337418723”&SBN=0;ESI=12,78&SBN=2 HTTP/1.1
Host: http://ipdcrepair.operator.com

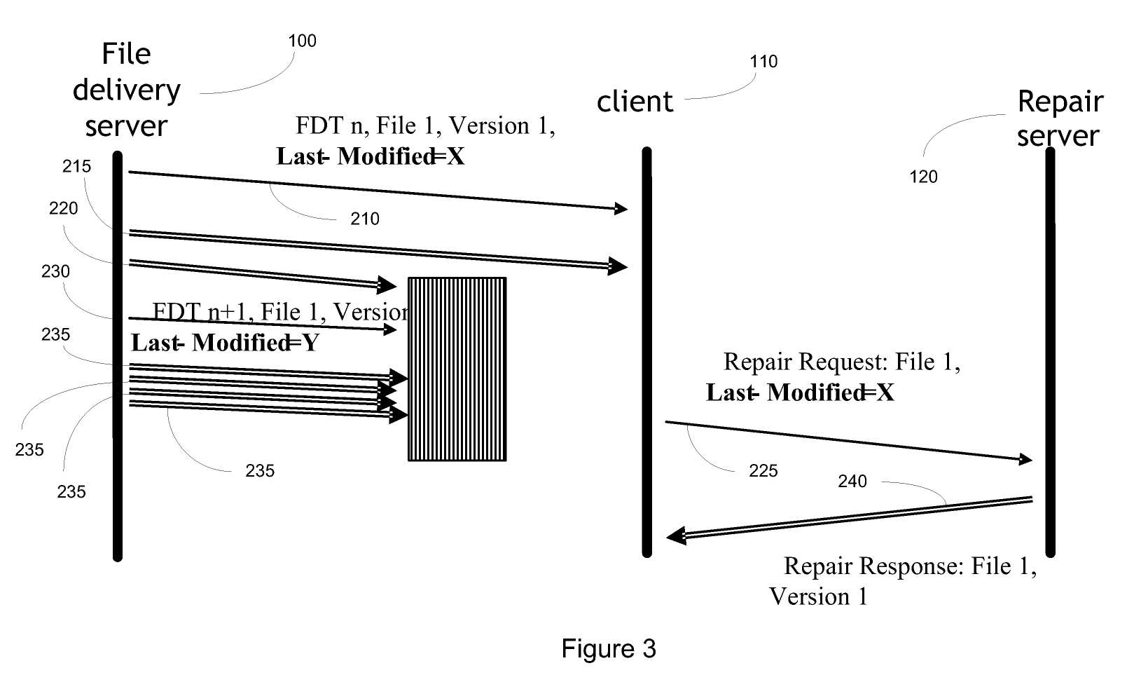

FIG. 3 shows a messaging diagram illustrating the file repair request process where a Last-Modified element is transmitted in the FDT. The system shown in FIG. 3 includes at least a file delivery server 100, a client 110, and a repair server 120. Delivery of the FDT n from the file delivery server 100 to the client 110, where the FDT n includes File 1, Version 1 is represented at 210. In addition, the FDT includes a Last-Modified value of X, where X can refer to an NTP timestamp or other date and time value, as described above. Delivery of the File 1, Version 1 to the client 110 is represented at 215. 220 is indicative of a portion of the File 1, Version 1 that is not received by the client 110. Alternatively, 220 can indicate that this portion of the File 1, Version 1 was received, for example, with a defect.

At some time between the transmission of the file repair request and the transmission of the missing encoding symbols representative of the last portion of File 1, a new version, i.e., File 1, Version 2 becomes available. 230 indicates delivery of the FDT n+1 to the client 110, where the FDT n+1 includes the File 1, Version 2 and a Last-Modified element with a value equivalent to Y. Delivery of the encoding symbols of the File 1, Version 2 that are consequently not delivered to the client 110 is indicated at 235. 225 represents a file repair request for the File 1 initiated by the client 110 to the repair server 120, where the request also includes the Last-Modified element value of X which identifies that the File 1 version requested is Version 1. Therefore, the repair server 120 responds to the file repair request with the proper version of File 1, i.e., Version 1 because File 1, Version 1 and File 1, Version 2 can be differentiated via their respective Last-Modified element values of X and Y.

The various embodiments of the present invention have the advantage of creating a more robust method of identifying file versions delivered in a file download session over FLUTE. In addition, the various embodiments of the present invention allow for more flexibility in realizing/implementing a file repair service because the synchronization effort needed to synchronize between a file delivery server and the file repair server is minimized. Although a file delivery server, e.g., file delivery server 100, is required to include more information about a file in the FDT than is conventionally required, this is only necessary for those files which are anticipated to be updated by the file delivery server.

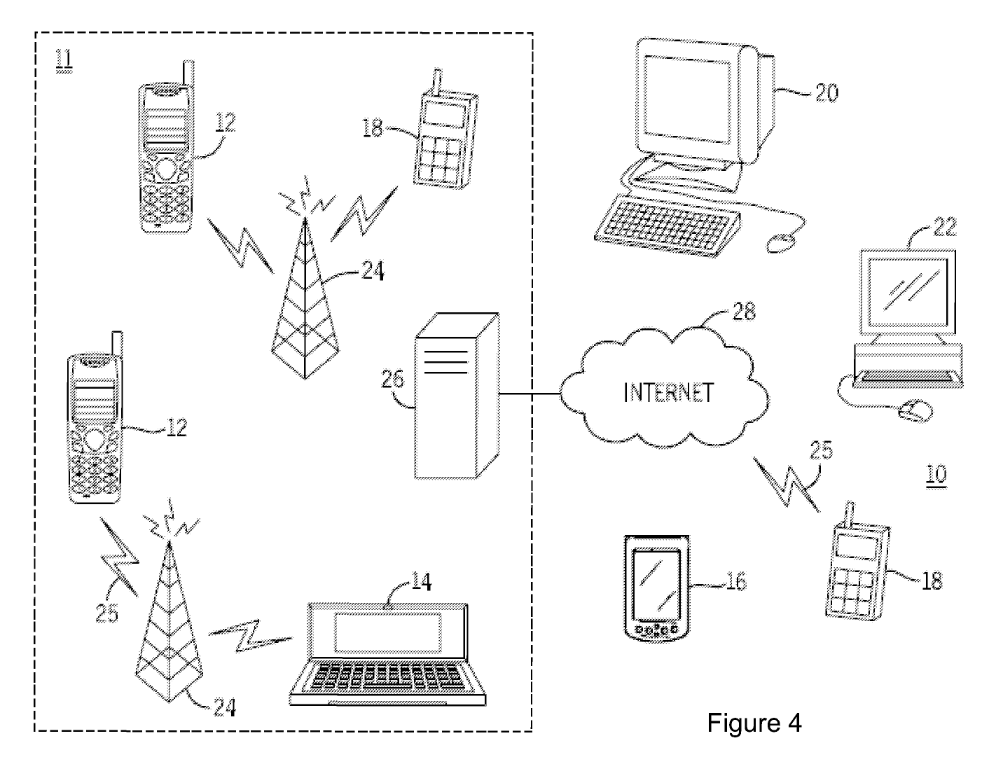

FIG. 4 shows a system 10 in which the present invention can be utilized, comprising multiple communication devices that can communicate through a network. The system 10 may comprise any combination of wired or wireless networks including, but not limited to, a mobile telephone network, a wireless Local Area Network (LAN), a Bluetooth personal area network, an Ethernet LAN, a token ring LAN, a wide area network, the Internet, etc. The system 10 may include both wired and wireless communication devices.

For exemplification, the system 10 shown in FIG. 4 includes a mobile telephone network 11 and the Internet 28. Connectivity to the Internet 28 may include, but is not limited to, long range wireless connections, short range wireless connections, and various wired connections including, but not limited to, telephone lines, cable lines, power lines, and the like.

The exemplary communication devices of the system 10 may include, but are not limited to, a mobile device 12, a combination PDA and mobile telephone 14, a PDA 16, an integrated messaging device (IMD) 18, a desktop computer 20, and a notebook computer 22. The communication devices may be stationary or mobile as when carried by an individual who is moving. The communication devices may also be located in a mode of transportation including, but not limited to, an automobile, a truck, a taxi, a bus, a boat, an airplane, a bicycle, a motorcycle, etc. Some or all of the communication devices may send and receive calls and messages and communicate with service providers through a wireless connection 25 to a base station 24. The base station 24 may be connected to a network server 26 that allows communication between the mobile telephone network 11 and the Internet 28. The system 10 may include additional communication devices and communication devices of different types.

The communication devices may communicate using various transmission technologies including, but not limited to, Code Division Multiple Access (CDMA), Global System for Mobile Communications (GSM), Universal Mobile Telecommunications System (UMTS), Time Division Multiple Access (TDMA), Frequency Division Multiple Access (FDMA), Transmission Control Protocol/Internet Protocol (TCP/IP), Short Messaging Service (SMS), Multimedia Messaging Service (MMS), e-mail, Instant Messaging Service (IMS), Bluetooth, IEEE 802.11, etc. A communication device may communicate using various media including, but not limited to, radio, infrared, laser, cable connection, and the like.

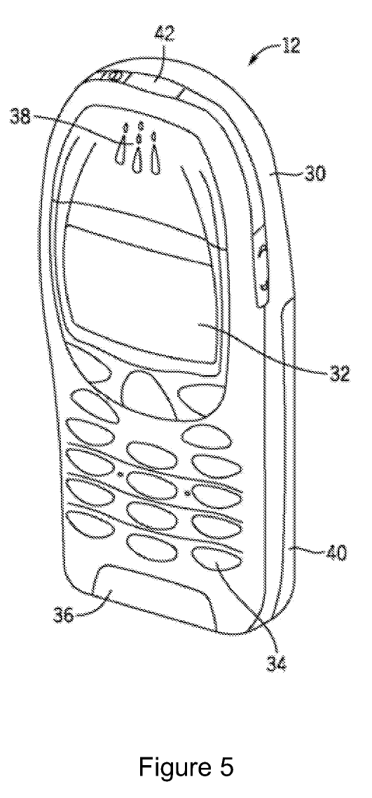

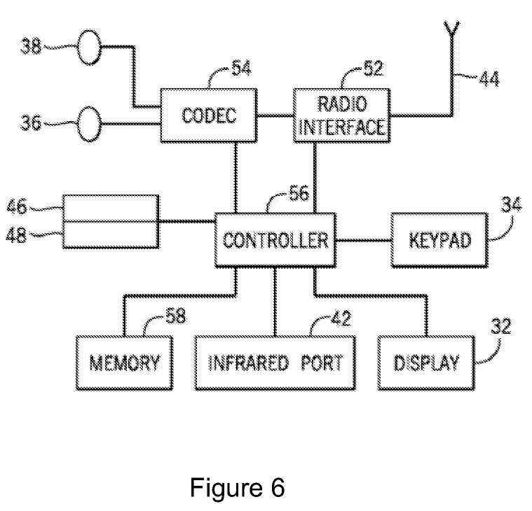

FIGS. 5 and 6 show one representative mobile device 12 within which the present invention may be implemented. It should be understood, however, that the present invention is not intended to be limited to one particular type of electronic device. The mobile device 12 of FIGS. 5 and 6 includes a housing 30, a display 32 in the form of a liquid crystal display, a keypad 34, a microphone 36, an ear-piece 38, a battery 40, an infrared port 42, an antenna 44, a smart card 46 in the form of a UICC according to one embodiment of the invention, a card reader 48, radio interface circuitry 52, codec circuitry 54, a controller 56 and a memory 58. Individual circuits and elements are all of a type well known in the art, for example in the Nokia range of mobile telephones.

The various embodiments described herein are described in the general context of method steps or processes, which may be implemented in one embodiment by a computer program product, embodied in a computer-readable medium, including computer-executable instructions, such as program code, executed by computers in networked environments. A computer-readable medium may include removable and non-removable storage devises including, but not limited to, Read Only Memory (ROM), Random Access Memory (RAM), compact discs (CDs), digital versatile disc (DVD), etc. Generally, program modules include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps.

Software and web implementations of various embodiments can be accomplished with standard programming techniques with rule based logic and other logic to accomplish the various database searching steps or processes, correlation steps or processes, comparison steps or processes and decision steps or processes. It should be noted that the words “component” and “module,” as used herein and in the following claims, is intended to encompass implementations using one or more lines of software code, and/or hardware implementations, and/or equipment for receiving manual inputs.

The foregoing description of embodiments of the present invention has been presented for purposes of illustration and description. The foregoing description is not intended to be exhaustive or to limit embodiments of the present invention to the precise form disclosed, and modifications and variations are possible in light of the above teachings or may be acquired from practice of the present invention. The embodiments discussed herein were chosen and described in order to explain the principles and the nature of various embodiments and its practical application to enable one skilled in the art to utilize the present invention in various embodiments and with various modifications as are suited to the particular use contemplated. The features of the embodiments described herein may be combined in all possible combinations of methods, apparatus, modules, systems and computer program products.

What is claimed is:

1. A method, comprising:
transmitting a first file delivery table and a first version of a file during a unicast session, the first file delivery table including a first file version indicator, to a client and a file repair server;
upon a determination that a second version of the file exists, transmitting a second file delivery table and a second version of the file, the second file delivery table including a second file version indicator, to the client.

2. The method of claim 1, further comprising transmitting a file repair request from the client to the file repair server if at least one portion of the first version of the file is one of not received by the client and defective, the file repair request including the first file version indicator.

3. The method of claim 2, further comprising receiving the file repair request, the file repair request being forwarded from the file repair server, and transmitting encoding symbols representative of the at least one portion of the first version of the file to the client.

4. The method of claim 2, wherein the file repair server has information regarding a blocking algorithm for reproducing the encoding symbols according to the unicast session.

5. The method of claim 4, further comprising transmitting encoding symbols to the client, the encoding symbols being representative of the at least one portion of the first version of the file.

6. The method of claim 1, wherein the first and second file version indicators each comprise one of hash values and last modification elements of the first and second versions of the file.

7. The method of claim 6, wherein the hash values comprise values according to message digest algorithm 5.

8. The method of claim 6, wherein the last modification elements comprise timestamp values regarding a last moment when each of the first and second versions of the file were created.

9. A computer program product, embodied on a computer-readable medium, comprising the processes of claim 1.

10. An apparatus, comprising:
a processor; and
a memory unit communicatively connected to the processor and including:
computer code for transmitting a first file delivery table and a first version of a file during a unicast session; the first file delivery table including a first file version indicator, to a client and a file repair server;
computer code for upon a determination that a second version of the file exists, transmitting a second file delivery table and a second version of the file, the second file delivery table including a second file version indicator, to the client.

11. The apparatus of claim 10, wherein the client further comprises computer code for transmitting a file repair request to the file repair server if at least one portion of the first version of the file is one of not received by the client and defective, the file repair request including the first file version indicator.

12. The apparatus of claim 11, wherein the memory unit further comprises computer code for receiving the file repair request, the file repair request being forwarded from the file repair server, and computer code for transmitting encoding symbols representative of the at least one portion of the first version of the file to the client.

13. The apparatus of claim 11, wherein the file repair server has information regarding a blocking algorithm for reproducing the encoding symbols according to the unicast session.

14. The apparatus of claim 13, wherein the file repair server comprises computer code for transmitting encoding symbols to the client, the encoding symbols being representative of the at least one portion of the first version of the file.

15. The apparatus of claim 11, wherein the first and second file version indicators each comprise one of hash values and last modification elements of the first and second versions of the file.

16. The apparatus of claim 15, wherein the hash values comprise values according to message digest algorithm 5.

17. The apparatus of claim 15, wherein the last modification elements comprise timestamp values regarding a last moment when each of the first and second versions of the file were created.

18. A method, comprising:
receiving a first file delivery table and a first version of a file during a unicast session; the first file delivery table including a first file version indicator;
transmitting a file repair request to a file repair server if at least one portion of the first version of the file is one of not received by the client and defective, the file repair request including the first file version indicator; and
receiving a file repair response, the file repair response including encoding symbols representative of the at least one portion of the first version of the file.

19. The method of claim 18, further comprising transmitting a second file delivery table and a second version of the file from a file delivery server, the second file delivery table including a second file version indicator.

20. The method of claim 19, wherein the second file version indicator comprises one of a hash value and a last modification element of the second version of the file.

21. The method of claim 20, wherein the hash value comprises a value according to message digest algorithm 5.

22. The method of claim 20, wherein the last modification element comprises a timestamp value regarding a last moment when the second version of the file was created.

23. The method of claim 18, wherein the file repair response includes encoding symbols, the encoding symbols being representative of the at least one portion of the first version of the file.

24. The method of claim 18, wherein the file repair response is received from the file repair server.

25. The method of claim 24, wherein the file repair server has information regarding a blocking algorithm for reproducing the encoding symbols according to the unicast session.

26. The method of claim 18, wherein the file repair response is received from a file delivery server, the file repair request being forwarded from the file repair server and including encoding symbols representative of the at least one portion of the first version of the file.

27. The method of claim 18, wherein the first file version indicator comprises one of a hash value and a last modification element of the first version of the file.

28. The method of claim 27, wherein the hash value comprises a value according to message digest algorithm 5.

29. The method of claim 27, wherein the last modification element comprises a timestamp value regarding a last moment when the first version of the file was created.

30. A computer program product, embodied on a computer-readable medium, comprising the processes of claim 18.

31. An apparatus, comprising:
a processor; and
a memory unit communicatively connected to the processor and including:
computer code for receiving a first file delivery table and a first version of a file during a unicast session; the first file delivery table including a first file version indicator;
computer code for transmitting a file repair request to a file repair server if at least one portion of the first version of the file is one of not received by the client and defective, the file repair request including the first file version indicator; and
computer code for receiving a file repair response, the file repair response including encoding symbols representative of the at least one portion of the first version of the file.

32. The apparatus of claim 31, wherein a file delivery server comprises computer code for transmitting a second file delivery table and a second version of the file to the client, the second file delivery table including a second file version indicator.

33. The apparatus of claim 32, wherein the second file version indicator comprises one of a hash value and a last modification element of the second version of the file.

34. The apparatus of claim 33, wherein the hash value comprises a value according to message digest algorithm 5.

35. The apparatus of claim 33, wherein the last modification element comprises a timestamp value regarding a last moment when the second version of the file was created.

36. The apparatus of claim 31, wherein the file repair response includes encoding symbols, the encoding symbols being representative of the at least one portion of the first version of the file.

37. The apparatus of claim 31, wherein the file repair response is received from the file repair server.

38. The apparatus of claim 37, wherein the file repair server has information regarding a blocking algorithm for reproducing the encoding symbols according to the unicast session.

39. The apparatus of claim 31, wherein the file repair response is received from a file delivery server, the file repair request being forwarded from the file repair server and including encoding symbols representative of the at least one portion of the first version of the file.

40. The apparatus of claim 31, wherein the first file version indicator comprises one of a hash value and a last modification element of the first version of the file.

41. The apparatus of claim 40, wherein the hash value comprises a value according to message digest algorithm 5.

42. The apparatus of claim 40, wherein the last modification element comprises a timestamp value regarding a last moment when the first version of the file was created.

43. A method, comprising:
receiving a file repair request from a client, the file repair request including a first file version indicator of a first version of a file; and
upon a determination that at least one portion of the first version of the file is one of not received by the client and defective, transmitting a file repair response to the client.

44. The method of claim 43, wherein a file delivery server transmits a second file delivery table and a second version of the file to the client, the second file delivery table including a second file version indicator.

45. The method of claim 44, wherein the second file version indicator comprises one of a hash value and a last modification element of the second version of the file.

46. The method of claim 45, wherein the hash value comprises a value according to message digest algorithm 5.

47. The method of claim 45, wherein the last modification element comprises a timestamp value regarding a last moment when the second version of the file was created.

48. The method of claim 43, further comprising forwarding the file repair request to a file delivery server, wherein the file repair response is transmitted to the client, the file repair response including encoding symbols representative of the at least one portion of the first version of the file.

49. The method of claim 43, wherein the file repair response is transmitted to the client by the file repair server, the file repair response including encoding symbols representative of the at least one portion of the first version of the file.

50. The method of claim 49, further comprising previously receiving a blocking algorithm for reproducing the encoding symbols according to a unicast session.

51. The method of claim 43, wherein the first file version indicator comprises one of a hash value and a last modification element of the first version of the file.

52. The method of claim 51, wherein the hash value comprises a value according to message digest algorithm 5.

53. The method of claim 51, wherein the last modification element comprises a timestamp value regarding a last moment when the first version of the file was created.

54. A computer program product, embodied on a computer-readable medium, comprising the processes of claim 43.

55. An apparatus, comprising:
a processor; and
a memory unit communicatively connected to the processor and including:
computer code for receiving a file repair request from a client, the file repair request including a first file version indicator of a first version of a file; and
computer code for upon a determination that at least one portion of the first version of the file is one of not received by the client and defective, transmitting a file repair response to the client.

56. The apparatus of claim 55, wherein a file delivery server comprises computer code for transmitting a second file delivery table and a second version of the file to the client, the second file delivery table including a second file version indicator.

57. The apparatus of claim 56, wherein the second file version indicator comprises one of a hash value and a last modification element of the second version of the file.

58. The apparatus of claim 57, wherein the hash value comprises a value according to message digest algorithm 5.

59. The apparatus of claim 57, wherein the last modification element comprises a timestamp value regarding a last moment when the second version of the file was created.

60. The apparatus of claim 55, wherein the memory unit further comprises forwarding the file repair request to a file delivery server, wherein the file repair response is transmitted to the client, the file repair response including encoding symbols representative of the at least one portion of the first version of the file.

61. The apparatus of claim 55, wherein the file repair response is transmitted to the client by the file repair server, the file repair response including encoding symbols representative of the at least one portion of the first version of the file.

62. The apparatus of claim 61, wherein the memory unit further comprises computer code for previously receiving a blocking algorithm for reproducing the encoding symbols according to a unicast session.

63. The apparatus of claim 55, wherein the first file version indicator comprises one of a hash value and a last modification element of the first version of the file.

64. The apparatus of claim 63, wherein the hash value comprises a value according to message digest algorithm 5.

65. The apparatus of claim 63, wherein the last modification element comprises a timestamp value regarding a last moment when the first version of the file was created.

66. A system, comprising:
a file delivery server configured to transmit a first file delivery table and a first version of a file during a unicast session; the first file delivery table including a first file version indicator, and upon a determination that a second version of the file exists, transmitting a second file delivery table and a second version of the file, the second file delivery table including a second file version indicator;
a client configured to receive the first file delivery table, the first version of the file, and the first file version indicator from the file delivery server, and upon a determination that at least one portion of the first version of the file is one of not received and defective, transmit a file repair request, the file repair request including the first file version indicator; and
a file repair server configured to receive the file repair request from the client, and transmit a file repair response to the client.

67. The system of claim 66, wherein the file repair response is one of the file repair request forwarded to the file delivery server, whereupon the file repair response is transmitted to the client, the file repair response including encoding symbols representative of the at least one portion of the first version of the file, and the file repair response is transmitted to the client directly by the file repair server, the file repair response including encoding symbols representative of the at least one portion of the first version of the file.
